(19) United States
(12) Patent Application Publication
(10) Pub. No.: US 2010/0131399 A1
(43) Pub. Date: May 27, 2010

(54) PARSER FOR GENERATING FINANCIAL MANAGER APPLICATION RULES

(75) Inventors: Dheeraj Anand, New Delhi (IN); Rojal Bhadke, Maharashtra (IN); Samatha Jagini, Pradesh (IN); Dileep George, Kerala (IN); Sivabalarajan Madasamy, Karnataka (IN); Prasad Tungaturthy, Stamford, CT (US)

Correspondence Address: Trellis IP Law Group/Oracle, 1900 Embarcadero Road, Suite 109, Palo Alto, CA, 94303, US

(73) Assignee: Oracle International Corporation, Redwood Shores, CA (US)

(21) Appl. No.: 12/398,385

(22) Filed: Mar. 5, 2009

(30) Foreign Application Priority Data
Nov. 27, 2008 (IN) 2968/CHE2008

(51) Int. Cl. G06Q 40/00

(52) U.S. Cl. 705/35

(57) ABSTRACT

In one embodiment, one or more business rules are received from a calculation manager. A calculation manager allows a user to generate the rules using a graphical format. The business rules are generated in a mark-up language, such as extensible mark-up language (XML). Data for the one or more business rules is loaded into a data structure for parsing. Data for the nodes may be read in by a token parser. When the token parser encounters a token, a business decision is determined. The token parser analyzes the data for the node to determine how to convert it to a business rule for the financial manager. This process continues as nodes are read in and with each token that is encountered, a business decision is determined until the rule for the financial manager is generated.

### BACKGROUND

Particular embodiments generally relate to data parsers.

A financial manager application can perform consolidation of data based on business rules that are written in a scripting language, such as visual basic script (VBscript). Users typically write these rules by hand and a programmer codes the rules in VBscript. Writing rules by hand may be a tedious and time-consuming process. One alternative is to use a calculation manager application to write these rules using a graphical user interface. The user can drag and drop components for a rule, which allows users to more easily generate the rules. However, the output from the calculation manager application is in a format that is not compatible with the financial manager application. For example, the calculation manager outputs its rules in a mark-up language, such as extensible mark-up language (XML) using its own calculation manager format (e.g., a syntax of the rules) that is not compatible with a financial manager format. Thus, the rules output by the calculation manager application are not in a format compatible with the financial manager application. Because of this, the rules output by the calculation manager cannot be loaded directly into the financial manager. Thus, users have to manually convert the calculation manager rules to financial manager rules and then load them into the financial manager. This is a tedious and highly error-prone task and also requires users to understand the calculation manager XML rules format in addition to the financial manager VBscript rules format. Also, the benefits gained by using the graphical user interface of the calculation manager are negated by still having to have a programmer manually convert the rules to the financial manager format.

### SUMMARY

Particular embodiments generally relate to parsing business rules generated from a calculation manager to business rules for a financial manager.

In one embodiment, one or more business rules are received from a calculation manager. A calculation manager allows a user to generate the rules using a graphical format. The business rules are generated in a mark-up language, such as extensible mark-up language (XML). Data for the one or more business rules is loaded into a data structure for parsing. For example, nodes are determined in the XML and loaded into a XML document object model (DOM). Data for the nodes may be read in by a token parser. When the token parser encounters a token, a business decision is determined. A token may be an operator in the business rule, such as an addition sign, variable assignment, and other operators. The token parser analyzes the data for the node to determine how to convert it to a business rule for the financial manager. This process continues as nodes are read in and with each token that is encountered, a business decision is determined until the rule for the financial manager is generated.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts a system for parsing calculation manager rules into financial manager rules according to one embodiment.

FIG. 2 depicts an example of a data structure according to one embodiment.

FIG. 3 depicts a more detailed example of a parser according to one embodiment.

FIG. 4 depicts a simplified flowchart of a method for determining financial manager rules according to one embodiment.

FIG. 5 shows an example of XML code.

### DETAILED DESCRIPTION OF EMBODIMENTS

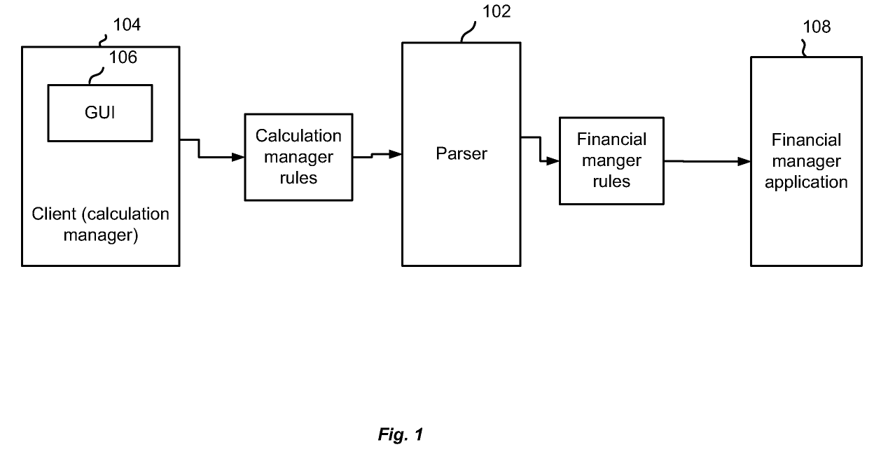

FIG. 1 depicts a system 100 for parsing calculation manager rules into financial manager rules according to one embodiment. As shown, a parser 102 is configured to receive calculation manager rules and parse them into financial manager rules. A client 104 may be used to generate the calculation manager rules. For example, a graphical user interface (GUI) 106 is used by a user to generate the calculation manager rules. Parser 102 then converts the calculation manager rules to financial manager rules, which may then be input into a financial manager 108.

Calculation manager (CM) is an application that is used to write business rules for financial management applications. Calculation manager allows a user to use GUI 106 to generate the rules in a graphical format. For example, a user may drag and drop different graphical objects in GUI 106 to generate rules. The graphical objects that are supported by calculation manager include formula, script, condition, member range, data range, and fixed loop. These graphical objects may be connected to form a business rule, which is referred to as a calculation manager rule. If a user wants to export the calculation manager rules, the calculation manager application can output them in a mark-up language. The calculation manager rules are output in a format that is understood by the calculation manager, but not by financial manager 108. For example, the syntax and form of the rule is in the calculation manager format.

Financial manager 108 may be an application that is used to perform financial analysis of data. For example, financial manager 108 is a consolidation product that is used to consolidate the financial cycle of a company. Although a financial consolidation product is discussed, it will be understood that other applications that process financial aspects of a company can be used. To consolidate the financial cycle, financial manager business rules are needed.

Financial manager 108 is configured to read financial manager business rules that are in a format compatible with it. For example, the language used is a scripting language or other text format, such as visual basic script (VBScript). The format is also a format that is associated with financial manager 108, such as .rle.

The conversion from calculation manager rules to financial manager rules is performed by parser 102. Parser 102 is configured to use conversion rules to determine how to parse calculation manager rules to financial manager rules. In one embodiment, the calculation manager rules are stored in a data structure, such as a tree structure. Nodes of the calculation manager rules are stored as nodes in an XML document object model (DOM). The DOM puts the XML in a tree format in memory, such as random access memory (RAM). By putting the XML in memory, the parsing can be performed faster.

Parser 102 then reads the nodes and parses the data of the nodes. For example, parser 102 is a token parser that parses the data bit by bit and attempts to map the parsed data to a financial manager rule. For example, the token parser reads data until a token is encountered. A token may be an operator in the calculation manager rules. Operators may be used to perform actions on data or manipulate data. Examples of tokens include variable assignment, addition, subtraction, multiplication, etc. When this occurs, the token parser determines information for parsing the data to a financial manager rule.

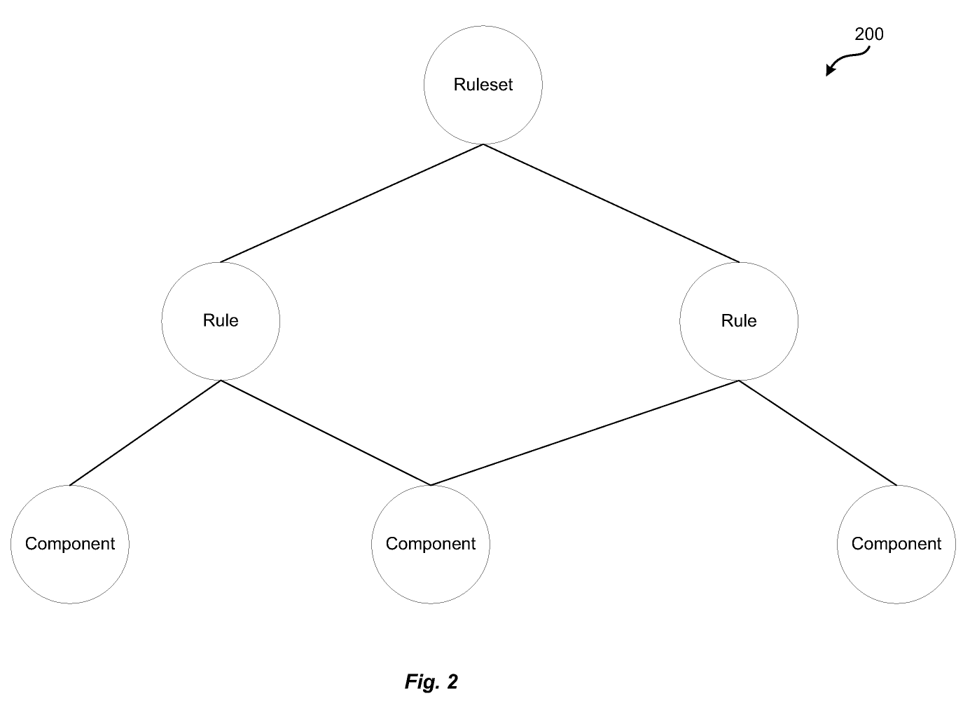

As mentioned above, parser 102 receives the calculation manager rules and can store them in a data structure. FIG. 2 depicts an example of a data structure 200 according to one embodiment. Data structure 200 may be a tree structure. Although a tree-like structure is described, it will be understood that other data structures may be used. For example, other structures that can store data in a nodal format can be used.

In one embodiment, the calculation manager rules are written in a mark-up language that is nodal in nature. For example, XML is written such that nodes may be determined. Each node of the XML may be stored in a node of the tree. In one example, parser 102 parses the calculation rules in the XML format and determines nodes from it. In one example, calculation manager may have three nodes that are considered: rulesets, rules, and components. A ruleset is a node that is used to define rules that are part of the ruleset. A rule is an expression that may be evaluated. A component is an entity that holds data that needs to be used by the rule. Calculation manager 104 formats the rulesets, rules, and components in their own start and end tags. An XML node may be data from the start tag of a ruleset, rule, or component to the end tag.

In one embodiment, the Ruleset, Rule, and Component nodes are kept in separate nodes of the tree structure. This makes the parsing easier as they can be fetched independently, parsed and kept ready for usage. For example, if there is Rule R1 and R2, both can be included in Ruleset RS1 and RS2 and thus are shared. When parsing the rules, the nodes for rules R1 and R2 may be retrieved when parsing Ruleset RS1 and RS2. This might not have been possible if both Rule R1 and R2 were within Ruleset RS1 as then they cannot be referred to inside Ruleset RS2. That is, if Rule R1 or R2 were found within Ruleset RS2, Ruleset RS1 would not be able to retrieve Rule R1 or R2.

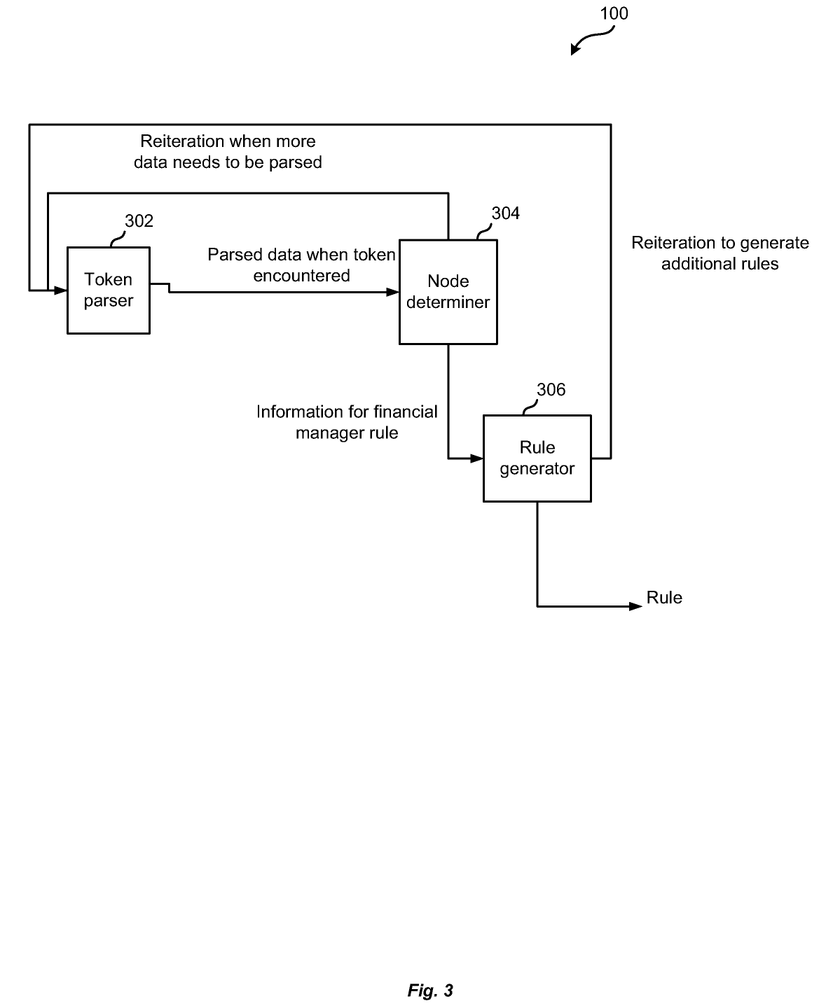

Each tree node includes data for the XML node. The data may be read in and parsed. FIG. 3 depicts a more detailed example of parser 102 according to one embodiment. Parser 102 includes a token parser 302, a node processor 304, and a data converter 306.

Token parser 302 parses the data for a node. In one embodiment, token parser 302 parses the data based on tokens. A token may be an operator that is found in the data. In one example, the formula A=B+C may be parsed. The parser first reads in the variable A. This is not considered a token because it is a variable that does not require an operation to be performed. Then, white space is read and the equal sign (“=”) is parsed. The equal sign is determined as a token as it is an assignment of the variable. When a token is encountered, a business decision needs to be determined. A business decision may be determining any information that is needed to convert the parsed data to a financial manager rule.

Token parser 302 provides better control on data that is being parsed. For example, the parsing is efficient and it controls every character of text that is being read in and parsed. Better decisions on generating financial manager rules can be determined because when tokens are encountered, business decisions are applied to determine how the data parsed should be converted to financial manager rules. Parsing XML rules based on tokens makes it easier to parse them into financial manager rules because corner cases may be handled. This allows corner cases to be handled better than in string parsing.

When the token is encountered, a node processor 304 is configured to process the data that has been parsed for the node. For example, not all the data for the node may have been parsed. However, reviewing the processing of the data when a token has been reached allows the financial manager rules to be generated in a more efficient manner. In this case, node processor 304 only has the variable A to consider. Node processor 304 can then determine how to convert the variable A into a financial manager rule. For example, node processor 304 examines the data that has been read in and determines how it can be converted. In this case, node processor 304 knows “=” is an assignment and that A is a left-hand side (LHS) of the assignment. Node processor 304 stores this information for later reference. The information that node processor 304 has received may not be sufficient to generate a financial manager rule. Accordingly, the process may reiterate to token parser 302 in which additional data for the node is read. For example, token parser 302 may read in data after the equal sign, which is white space. The data of a variable of B is read in, and then an addition “+” sign. The addition sign is considered a token and the parsing stops here.

Node processor 304 then reviews the data that has been parsed to convert it. In this case, node processor 304 knows an assignment has been encountered and looks for an argument. In this case, the first argument is determined and that is B. Node processor 304 then saves the argument of B and determines that additional parsing should be performed. In this case, node processor has saved the variables of A and B and the tokens of = and +.

Token parser 302 then continues reading data for the node, which is a white space and then the variable C. The end of the expression is encountered and parsing stops. Node processor 304 determines from the data being parsed that this is a second argument for the addition sign. Node processor 304 has parsed the data for the node and now has full details of the expression. This expression can now be converted to another format. For example, rule generator 306 uses the information from node processor 304 to generate a financial manager rule. In this case, the equivalent of A=B+C in the financial manager format for rules is determined. The financial manager rule is generated by taking the left-hand assignment, the equal sign token, the arguments B and C, and the addition sign token and determining an equivalent statement in the format for the financial manager rules. By individually parsing the expression in the calculation manager format, the financial manager format can be easily determined.

The above process continues as each node is read in and parsed. In practice, information from other nodes may be needed to generate rules. In this case, the information for the other nodes may be kept in memory and as additional nodes are read, financial manager rules are generated.

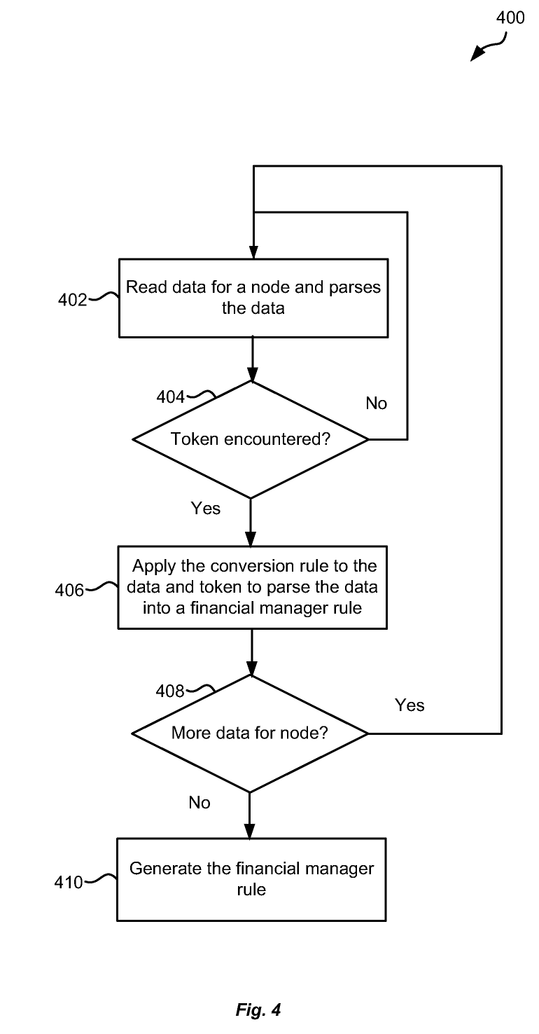

FIG. 4 depicts a simplified flowchart 400 of a method for determining financial manager rules according to one embodiment. In step 402, parser 102 reads data for a node and parses the data. Step 404 determines if a token is encountered. If a token is not encountered, the process reiterates to step 402 to read additional data. If a token is encountered, parser 102 determines a conversion rule associated with the data and token. The conversion rule may be rules that interpret the data that has been parsed from the calculation manager rule. For example, depending on the token encountered, the data read is analyzed to determine its relationship to the token.

In step 406, parser 102 applies the conversion rule to the data and token to parse the data into a financial manager rule. For example, if information for a financial manager rule can be determined, it is stored in memory for later use.

In step 408, it is determined if there is more data to be read for the node. If so, the process reiterates to step 402. Data continues to be parsed until a financial manager rule can be generated. When additional data is not needed, step 410 generates the financial manager rule. For example, the data that has been identified from the calculation manager rule is used to determine how to generate a financial manager rule.

In converting the calculation manager rules to a format that financial manager can understand, different features may be provided by parser 102. For example, a timer feature, call stack feature, and disabled rules may be provided.

The timer feature is used to insert timer statements in financial manager rules. Financial manager 108 may be a consolidation product and is used to close the financial cycle of a company in one embodiment. During consolidation, it is not known how much time was taken to consolidate an entity. For example, an entity may be a business unit of a company, such as a branch of an office. When parser 102 converts calculation manager rules to financial manager rules, timer statements may be inserted into the financial manager rules such that when the converted financial manager rules are run within financial manager 108, the time taken to consolidate the entity is logged. This helps financial manager administrators to fine-tune the calculation manager rules for that entity if the consolidation for that entity is too slow. Also, the timer provides a performance comparison between old rules and new rules.

A call stack is also provided. The format of the calculation manager rules is a complex format and includes various sections and categories, such as rulesets, rules, and components. A ruleset can refer to multiple rules and a rule can refer to multiple components. During conversion, an error may occur because there is some data that parser 102 cannot understand or convert to the financial manager rules. For example, suppose a ruleset RS1 is calling a rule R1, which in turn calls a component C1, and C1 has a syntax error or is storing some data that cannot be understood. As parser 102 is parsing the expression, data is stored in the call stack that indicates what has been converted. For example, the ruleset that was interpreted and the rule that was interpreted is stored. This call stack is then output such that the user can view where the error occurred. For example, the user would be able to determine that data being stored by the component C1 may be causing an error.

In one example, suppose a component C1 has the following formula stored:

Out=DoSomething ( ).

In the example above, the variable Out is supposed to take the output of the function DoSomething. But parser 102 does not understand the function DoSomething. That is, parser 102 cannot parse the function DoSomething into a function that can be understood by financial manager 108. Accordingly, the following call stack may be output:

Invalid function−DoSomething (12400)

C1(T in type=C in component, ID=343)

R and R1(T in type=R in rule, ID=129)

RS1(T in type=R in ruleset, ID=12).

The above call stack means that the component C1 had a problem and this component C1 has been called by rule R1. Also, the call stack indicates that rule R1 has been called by ruleset RS1. In this way, a user can start from ruleset RS1 and fix the calculation manager rule in GUI 106. Thus, the user can see where the conversion failed as the node is being parsed.

Another feature that is provided by parser 102 is disabled rules. Sometimes, a user may not want calculation manager rules to be converted and then executed by financial manager 108. In one solution, a user can remove the rule from the calculation manager rules. However, this may be tedious and also the user may want this rule to be executed in the future. Accordingly, an indication in the calculation manager rules may be used to disable the rule. For example, parser 102 may reach the indication and convert the rule from the calculation manager rule to the financial manager rule. However, parser 102 disables the rule. For example, parser 102 may generate the converted rule as a comment. Thus, the rule may not be executed by financial manager 108. However, when the user wants to activate the rule, the comment sign can be taken out.

When a rule was not disabled, the rule may be converted as:

out=DoSomething( ).

However, when it is disabled, it may be converted as:

disabled−out=DoSomething( ).

This may be treated as a comment by financial manager 108 and is thus not executed. When the user wants to activate the rule, the term disabled is removed.

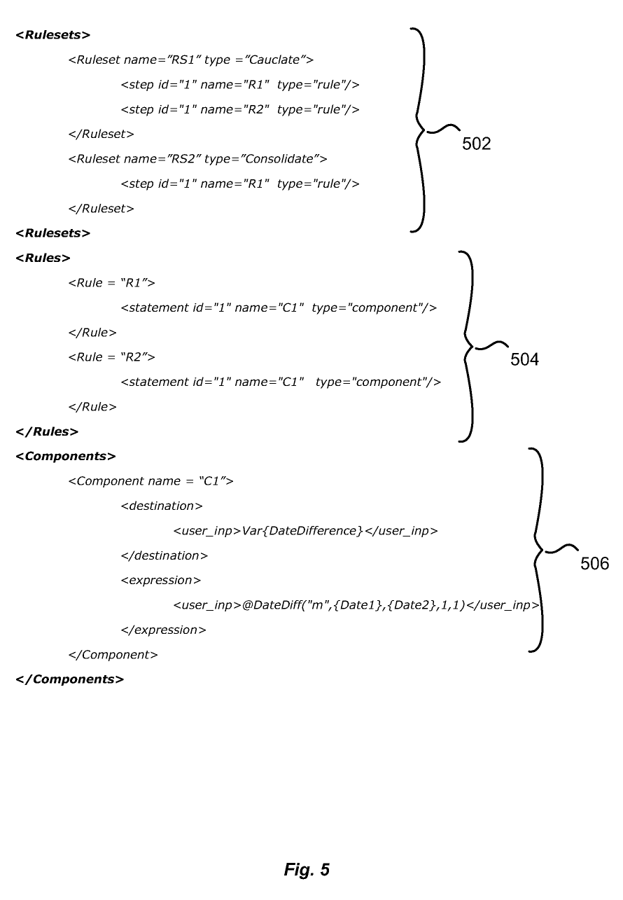

An example of converting a sample of calculation manager XML rules to a financial manager format (.rle) will now be described. FIG. 5 shows an example of the XML code. The calculation manager rules include the nodes of rulesets 502, rules 504, and components 506. Ruleset node 502 is stored in a first node of the DOM or the data structure; rules node 504 is stored in another node; and components node 506 is stored in a third node.

Token parser 302 first retrieves the rulesets 504 node and starts to process it. Although one ruleset, rules, and components node is shown, it will be understood that multiple ruleset, rules, and components nodes may be appreciated.

In the above example, the ruleset node is parsed. In this case, the ruleset of RS 1 is determined. It is determined that this is a ruleset and that rules may need to be referenced by the ruleset. Accordingly, additional data is parsed until the rules are determined. In this case, R1 and R2 are determined as the rules that the ruleset RS1 is referring to. These rules may be stored in other nodes. Also, the data of the ruleset is parsed and it is determined that the ruleset RS2 also includes the rule of R2. This means that the ruleset of RS1 and RS2 share the rule R2.

The rules node R1 is then read in and parsed. In this case, rule R1 refers to the component C1. Also, a rule R2 refers to the component C1. This means that component C1 holds the data that needs to be parsed and understood for these rules. In this case, the data is shown in 508. Parser 102 first reads in ˜(DataDifference)˜ from the destination node and parses it. Parser 102 then determines that this is a variable. For the node expression, the term @DateDiff (“n”, ˜Date1˜, ˜Date2˜, 1, 2) is determined from expression node 512. From this it determines that this is a function with five arguments of N, Date 1, Date2, 1, and 2. In this case, parser 102 decides that there needs to be a variable assignment and converts the above data to

DataDifference=DateDiff(“m”, Date1, Date2, 1,2)

As component C1 is referred to by both rule R1 and R2, both R1 and R2 need to be converted. R1 and R2 are thus converted as follows. These rules above show that the component is also shared.

Now to be sure that components R1 and R2 are referenced by the ruleset RS1 and RS2, RS1 and RS2 are converted to as follows:

```
Sub Calculate( )
    Call R1
    Call R2
End Sub
Sub Consolidate( )
    Call R1
End Sub
```

The final output of the financial manager rules is:

```
Sub Calculate( )
    Call R1
    Call R2
End Sub
Sub Consolidate( )
    Call R1
End Sub
Sub R1
    DataDifference = DateDiff(“m”, Date1, Date2, 1,2)
End Sub
Sub R2
    DataDifference = DateDiff(“m”, Date1, Date2, 1,2)
End Sub
```

Another example will be described to show the benefits of using a token parser. When a token is encountered, a business decision is made. Consider A=B+C, when the = token is encountered, the token parser knows that A was encountered before reaching the = token. So this business decision determines if A has some special meaning in HFM rules and, if yes, the rule is applied. For example, the rule may be change “A” to Name. So the parsed data will be Name=′. Then the parser encounters + (after reading B, but as B is not a token it is skipped). Now the parser knows it saw B before the + token and as B has no business rule attached with it, the parser adds it to ‘Name=’ to make it Name=B+. Now the parser goes to C and as it is not a token, the parser tries to get the next character. But there is no more data and C has no special meaning so the parser adds it to Name=B+C.

Now if token parsing is not performed and normal string manipulation is performed, the process might be time consuming and not efficient. Considering the following rules:

Replace A with NameA

Replace Z with NameZ

Replace D with NameD

Replace L with NameL.

So to parse A=B+C, the parser needs to search above 4 rules one by one within A=B+C, which is time consuming. And if there are thousands of such rules, the processing (i.e., the product) will become slow.

In a corner case, there are two expression, 1) A&B=B+C and 2) AA=B+C. Now first should become NameA&B=B+C and second should not change at all. Without the token parser it will be very difficult do differentiate between A& and AA as & is not a token now (as it is not a token parser). For example, the string parser might not be able to determine the letter A in the string A& as “A”. Rather, the string is interpreted as A&, which does not equal one of the rules (e.g., the rule for A). Thus, the conversion is not performed.

Although the description has been described with respect to particular embodiments thereof, these particular embodiments are merely illustrative, and not restrictive. Although financial manager and calculation manager are described, it will be understood that other applications may be used.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1 A method comprising:
receiving one or more business rules generated from a graphical format of a calculation manager, the one or more business rules generated in a first language and first format;
loading data for the one or more business rules into a structure for parsing;
reading data for a node in the set of nodes of the structure until data in the node is encountered in which a business decision is needed; and
parsing data read for the node to facilitate conversion of the parsed data to a financial manager rule in a second format and a second language compatible with a financial manager based on a conversion rule associated with the business decision.

2. The method of claim 1, wherein reading and parsing comprising:
reading a first node of the structure;
determining if a token is encountered;
if a token is encountered, determining that the business decision is needed.

3. The method of claim 2, further comprising:
if the token is not encountered, reading additional data for the node until a token is encountered.

4. The method of claim 1, wherein the data stored for the data structure is a ruleset, wherein the ruleset is parsed based on rules the ruleset is referring to.

5. The method of claim 4, wherein the data stored for the data structure is a rule, the rule referring to a component.

6. The method of claim 5, wherein the data stored for the data structure is a component.

7. The method of claim 1, wherein the first language is extensible markup language and the second language is a scripting language.

8. The method of claim 1, wherein the first language is nodal and the calculation manager rules are broken into nodes and stored in the data structure, wherein the nodes store rulesets, rules, and components.

9. The method of claim 1, further comprising:
inserting a timer statement into the financial manager rules, the timer statement allowing a time to be recorded when the financial manager rules are executed by the financial manager, the time recorded indicating a time taken to perform a financial transaction.

10. The method of claim 1, further comprising:
determining a disable statement in the calculation manager rules;
inserting a comment statement in one of the converted financial manager rules, the comment statement disabling execution of the one of the converted financial manager rules.

11. The method of claim 1, further comprising:
storing status of the parsing in a call stack;
determining when an error occurs during parsing; and
outputting the call stack, the call stack including information on the status of the parsing before the error occurred.

12. A computer-readable medium comprising encoded logic for execution by the one or more processors, the logic when executed operable to:
receive one or more business rules generated from a graphical format of a calculation manager, the one or more business rules generated in a first language and first format;
load data for the one or more business rules into a structure for parsing;
read data for a node in the set of nodes of the structure until data in the node is encountered in which a business decision is needed; and
parse data read for the node to facilitate conversion of the parsed data to a financial manager rule in a second format and a second language compatible with a financial manager based on a conversion rule associated with the business decision.

13. The computer-readable medium of claim 12, wherein logic operable to read and parse comprising logic operable to:
read a first node of the structure;
determine if a token is encountered;
determine that the business decision is needed if a token is encountered.

14. The computer-readable medium of claim 13, wherein the logic when executed is further operable to read additional data for the node until a token is encountered if the token is not encountered.

15. The computer-readable medium of claim 12, wherein the first language is nodal and the calculation manager rules are broken into nodes and stored in the data structure, wherein the nodes store rulesets, rules, and components.

16. The computer-readable medium of claim 12, wherein the logic when executed is further operable to insert a timer statement into the financial manager rules, the timer statement allowing a time to be recorded when the financial manager rules are executed by the financial manager, the time recorded indicating a time taken to perform a financial transaction.

17. The computer-readable medium of claim 12, wherein the logic when executed is further operable to:
determine a disable statement in the calculation manager rules;
insert a comment statement in one of the converted financial manager rules, the comment statement disabling execution of the one of the converted financial manager rules.

18. The computer-readable medium of claim 12, wherein the logic when executed is further operable to:
store status of the parsing in a call stack;
determine when an error occurs during parsing; and
output the call stack, the call stack including information on the status of the parsing before the error occurred.

19. The computer-readable medium of claim 12, wherein the data stored for the data structure comprises a ruleset, rule, and component.

20. An apparatus comprising:
one or more processors; and
logic encoded in one or more tangible media for execution by the one or more processors and when executed operable to:
receive one or more business rules generated from a graphical format of a calculation manager, the one or more business rules generated in a first language and first format;
load data for the one or more business rules into a structure for parsing;
read data for a node in the set of nodes of the structure until data in the node is encountered in which a business decision is needed; and
parse data read for the node to facilitate conversion of the parsed data to a financial manager rule in a second format and a second language compatible with a financial manager based on a conversion rule associated with the business decision.
